(19) United States
(12) Patent Application Publication
(10) Pub. No.: US 2019/0030685 A1
(43) Pub. Date: Jan. 31, 2019

(54) PRECISION POSITIONING DEVICE

(71) Applicant: SAFRAN AIRCRAFT ENGINES MEXICO S.A. DE C.V., Colón, Querétaro (MX)

(72) Inventors: Mickael DE ARAUJO, Santiago de Queretaro (MX); Yohannes MARCELET, Queretaro (MX)

(21) Appl. No.: 16/072,434

(22) PCT Filed: Jan. 27, 2017
(86) PCT No.: PCT/IB2017/000058

§ 371 Date: Jul. 24, 2018

(30) Foreign Application Priority Data
Jan. 29, 2016 (FR) 1650751

(51) Int. Cl. B25B 5/00; B25B 5/10

(52) U.S. Cl. CPC B25B 5/006; B25B 5/10

(57) ABSTRACT

A precision positioning device extending along an axis to be maintained in a first opening of a mechanical part, includes an axial element provided with a passage, a nut, a support and a moveable element, the axial element being integral with the support, and including a first screw thread for mounting the nut on the axial element, the nut providing an axial stop blocking the axial movement of the axial element relative to the nut, the axial element having an end portion including a deformable cylindrical male profile, adapted to cooperate with the inner circumference of the first opening, the deformation or radial expansion of the end of the axial element being driven by the action of the insertion of the moveable element in movement in the passage of the axial element in the direction of the end of the axial element.

### FIELD

The field of the invention relates to precision positioning devices to operate by means of a tooling on a mechanical part. The field of the invention more particularly relates to precision positioning devices for the positioning of a tooling on a mechanical part of an aircraft propulsion unit to carry out certain operations such as the handling of the part, its lifting or its displacement more generally.

### PRIOR ART

Parts such as those of a main propulsion unit of an aircraft are generally parts that have to be handled, during their assembly, with great precision by means of specific tools. One problem is that these mechanical parts, often of large dimensions, have to be handled with great precaution.

When such a part is handled, a known problem is the control of the applied stresses and their distribution in order to avoid any degradation of the mechanical part.

There exists, for example, a tooling making it possible to lift mechanical parts, notably the part forming the outer casing of the double flux engine of the propulsion unit or instead a fan disc for turbojet engine. The latter include openings spread out all around their circumference notably to offer fastening zones so that the tooling can be fixed thereto.

One problem is positioning the lifting apparatus on the mechanical part in a precise manner. Indeed, the needs for precision positioning are of the order of a 1/100th of a millimetre during the fastening of the lifting apparatus on the mechanical part. Today, there exists a need for a positioning device making it possible to obtain such precision in a reliable and recurrent manner.

Another problem is that the mechanical part may undergo chemical attacks when it is treated in an acid bath. Hence, the lifting tooling is also brought to be treated since it is made integral with the latter during this operation. It is thus necessary that, if need be, the positioning device is designed to minimise its sensitivity to acid during this same operation.

At present, the technique used to obtain positioning of the tooling is the use of moveable plates directly mounted on the tooling by means of pivots. However, one problem is the wear of these pivots, and thus the positioning defect that it is going to generate over time. Consequently, numerous parts have to be replaced on account of the wear of this pivot. The wear is notably due to the acid attacks that the tooling is going to undergo during operations of passage in an acid bath.

### SUMMARY OF THE INVENTION

The invention makes it possible to resolve the aforementioned drawbacks.

Notably, the invention offers an alternative to the prior art by proposing a positioning device made independent of the lifting tooling or which can be separated simply before the passage in an acid bath.

One object of the invention relates to a precision positioning device extending along an axis and intended to be maintained in a first opening of a mechanical part. The precision positioning device of the invention includes an axial element provided with a passage, a nut, a support and a moveable element, notably a tip or a slide, said axial element being integral with the support, and comprising a first screw thread for mounting the nut on said axial element, said nut providing an axial stop blocking the axial movement of the axial element relative to the nut, said axial element having, moreover, an end portion comprising a deformable cylindrical male profile, adapted to cooperate with the inner circumference of the first opening, the deformation or radial expansion of the end of the axial element being driven by the action of the insertion of the moveable element in movement in the passage of the axial element in the direction of the end of the axial element.

According to one embodiment, the support forms a gripping element making it possible to drive the screwing down of the axial element into the nut.

According to one embodiment, the precision positioning device comprises a screw forming a drive element tending to the elastic spacing of the deformable end, the thread of said screw cooperating with a tapping of the support and driving in axial movement the moveable element in order to engage the spacing of the cylindrical male profile of the free end of the axial element.

According to one embodiment, the cylindrical male profile of the free end of the axial element includes at least one groove favouring the radial spacing of the cylindrical male profile.

According to one embodiment, the free end of the axial element includes a plurality of grooves extending on a longitudinal portion of the end and enabling a homogeneous spacing of the axial element.

According to one embodiment, the positioning device includes at least one finger pivotably mounted on the nut and comprising, moreover, a working part making it possible to achieve a radial maintaining during the tightening driven by the rotation of the assembly formed of the axial element and support.

According to one embodiment, the support, the nut and the axial element are made of aluminium and the fingers and the moveable element are made of steel.

According to one embodiment, the precision positioning device includes, moreover, an alignment device including at least one second opening for the passage of a portion of the axial element, the opening cooperating with at least one working portion of at least one finger and a portion of the axial element.

Another object of the invention relates to a system for positioning a tooling structure on a mechanical part, said structure including at least one opening, said mechanical part including a first opening intended for the insertion of a positioning device of the invention, the positioning device being made integral with the first opening by the actuation of the screw to:
align at least one third opening of the alignment device with at least one opening of a tooling structure.

Another object of the invention relates to a method for mounting a positioning device of the invention, said positioning being carried out on a mechanical part comprising at least one opening for the passage of a maintaining end piece corresponding to a free end of the positioning device, characterised in that it includes:
A step of positioning at least one mask on the mechanical part in order to place and support a tooling of the mechanical part;
A step of fastening an alignment device with the positioning device by the action of screwing down the axial element with respect to the nut;
A step of positioning the positioning device and the alignment device in the opening of the mechanical part;
A step of tightening in order to fasten the positioning device on the mechanical part by the action of an axial component of a movement of the moveable element with respect to the axial element driving the spacing of the free end of said positioning device in such a way that the portion of the free end exerts a radial effort in said opening.

### BRIEF DESCRIPTION OF THE FIGURES

Other characteristics and advantages of the invention will become clear on reading the detailed description that follows, with reference to the appended figures, which illustrate:

FIGS. 1A, 1B: a positioning device of the invention in perspective view and in axial sectional view;

FIG. 1C: one embodiment of an axial element of the invention according to an axial sectional view;

FIG. 1D: one embodiment of a moveable finger of the invention according to a side view;

FIGS. 2A, 2B: different views of a mounting of the lifting tooling on a mechanical part thanks to the positioning device of the invention;

FIGS. 3A, 3B: different perspective and sectional views of the positioning device when it is coupled with an alignment device;

FIG. 4: a mounting of the positioning device on a mechanical part to which will be fixed a lifting tooling by means of a screw nut system.

### DESCRIPTION

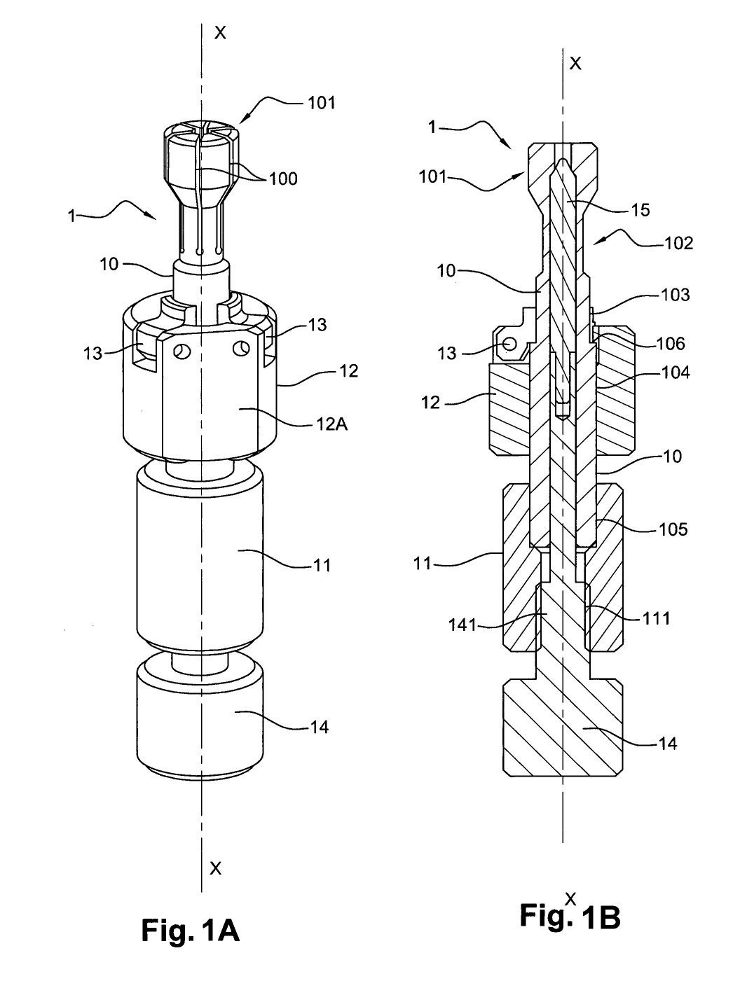

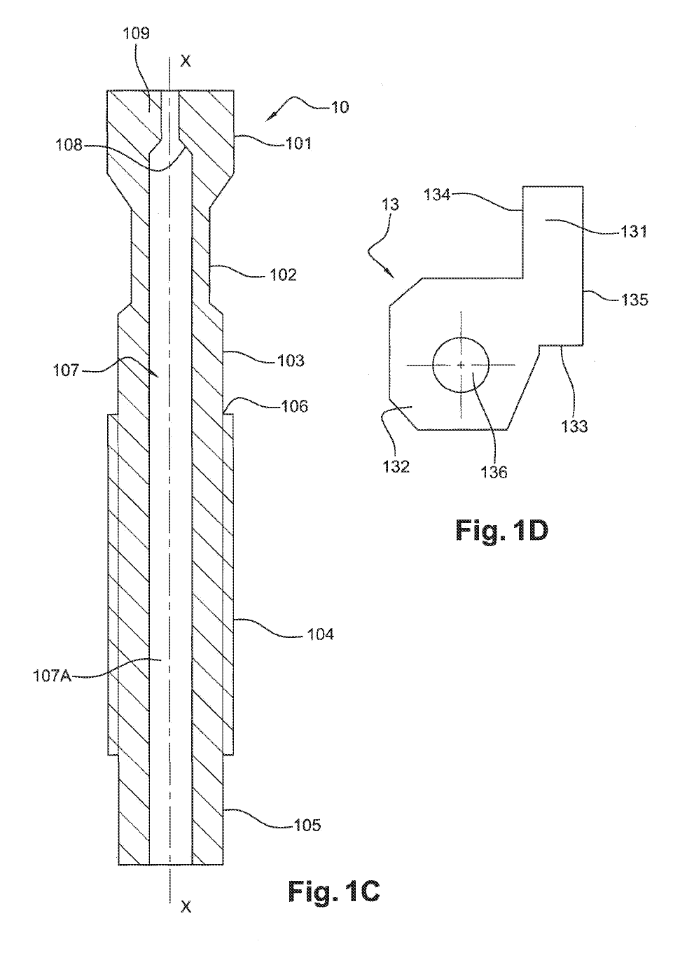

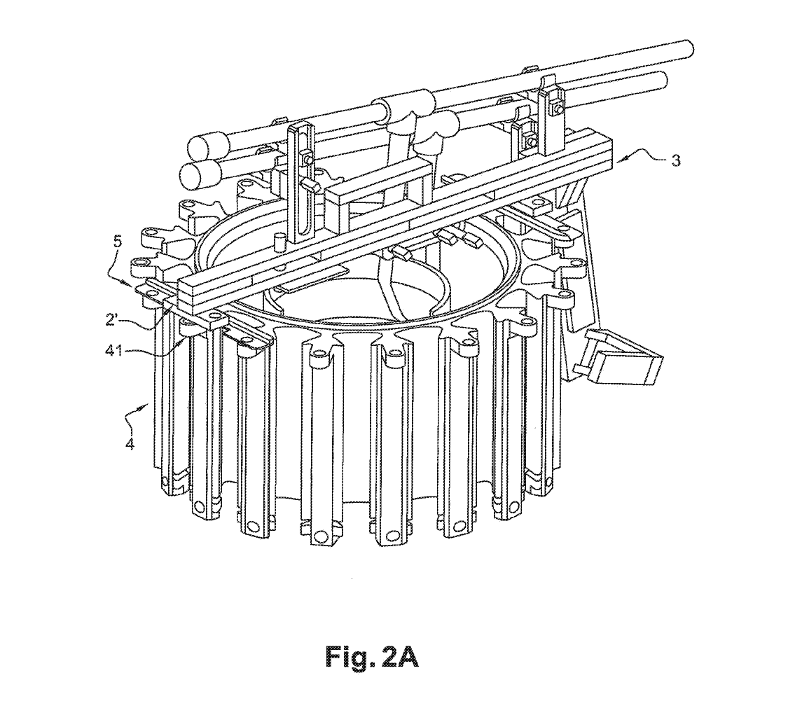

According to one embodiment, FIG. 1A represents a perspective view of a positioning device 1 of the invention and the main elements that compose it. FIG. 1B represents the same positioning device 1 in axial sectional view and makes it possible to represent the inner layout, the contacts and the cooperation points of the main elements of the positioning device 1.

The positioning device 1 of the invention includes an axial element 10 which is tightly mounted on a support 11. The portion of the axial element 10 tightly mounted on the support is noted 105 in FIG. 10.

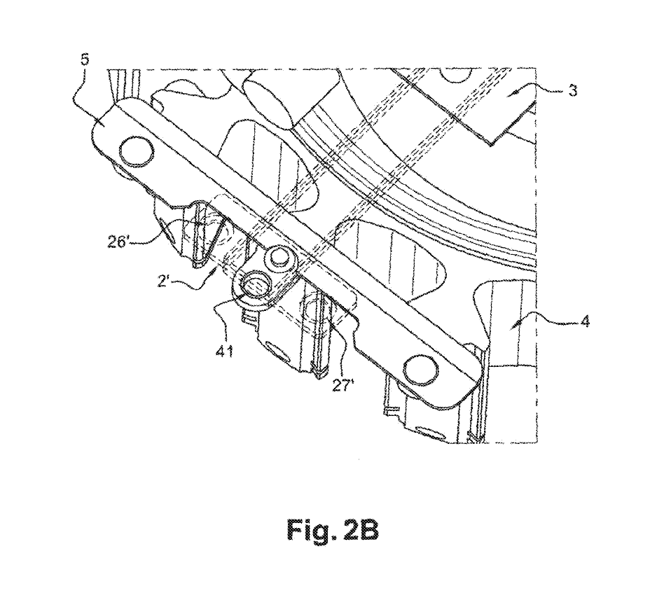

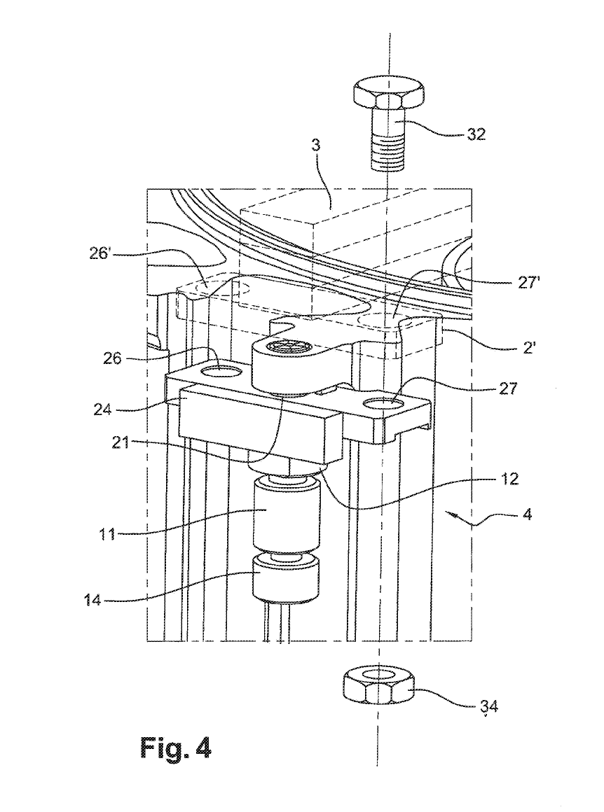

The axial lengthened element 10 extends along a longitudinal axis X-X and includes different portions, notably represented in FIG. 1C:
a first portion 101 of free end, of substantially cylindrical cross-section. The first portion 101 is intended to cooperate with the inner diameter of an opening of a mechanical part 4 represented in FIG. 2A or FIG. 4 in order to maintain in a reversible manner the positioning device 1 in an opening of an alignment device 2;
a second portion 102, adjacent to the free end 101, of substantially cylindrical cross-section including a reduction of the diameter relative to the diameter of the first portion 101. This reduction in diameter is realised in order to enable the bending of the legs of the zone 101 and to be able to tighten the mechanical part 4. It enables the passage of the positioning device 1 in an opening of an alignment device 2 represented in FIG. 4,
a third portion 103, substantially smooth, of substantially cylindrical cross-section, extending the second portion 102 opposite the first portion 101 and including an intermediate diameter between that of the first portion 101 and that of the second 102,
a fourth intermediate threaded portion 104, of substantially cylindrical cross-section of diameter greater than that of the third portion 103, for screwing down a nut 12 on the outer surface of the axial element 10,
a fifth end portion 105 opposite to the first portion 101, of substantially cylindrical cross-section, of diameter less than the largest dimension of the screw thread of the fourth portion 104, tightly mounted in a support 11 to ensure its maintaining,
a shoulder 106 separating the third and fourth portions 103, 104,
an axial passage 107, of diameter less than that of the second portion 102, passing right through the axial element 10 to emerge in the end faces of said axial element, said axial passage including a first long section 107A, straight, of substantially constant diameter, said long section emerging in the end face on the side of the fifth portion 105, extended by a substantially conical contraction 108, itself extended by a short straight section 109 and of diameter less than that of the long section 107A, said short section emerging in the end face on the side of the first portion 101.

The support 11 has two main functions. A first function consists in enabling the screwing down of a screw 14 in order to drive a moveable element 15, such as a tip or a slide, axially in the passage 107 of the axial element 10. To fulfil this function, the support 11 includes an axial tapped zone 111 enabling the screwing down of the threaded part 141 of the screw 14.

A second function consists in making it possible to arrange a gripping element to rotationally drive the axial element 10 and thereby to obtain a relative translational movement along the axis X-X between the axial element 10 and the nut 12. To fulfil this function, the axial element 10 is tightly mounted in a hollow zone of the support 11.

The nut 12 forms an element arranged externally with respect to the axial element 10. The nut 12 includes a flat spot 12A laid out on its outer surface, the flat spot being capable of cooperating with a complementary flat surface of the alignment device 2. The nut 12 forms a stop element so as to stop the translational and rotational movement of the axial element 10 during its insertion in an opening of the alignment device 2. This insertion is implemented during the operation of making integral the alignment device 2 and the positioning device 1.

The alignment device 2, forming a main plate, is provided with a central opening 21 to insert therein the positioning device 1 and two lateral openings 26 and 27. Moreover, the alignment device 2 includes a secondary plate 24. The secondary plate 24 is arranged substantially in a plane perpendicular to the main plate 2, to which it is integrally fastened. One of the two faces of the secondary plate 24 is facing the nut 12. Said face is in contact with the flat spot 12A which prevents the nut 12 from pivoting with respect to the axis X-X.

The alignment device 2 is laid out so as to be facing a second alignment device 2′ integral with the tooling 3 as is represented in FIG. 2B. In FIG. 2B, according to one embodiment, such a plate 2′ is welded to the tooling 3. The second alignment device 2′ extends longitudinally along one main axis in a same direction as a mask 5 for positioning the tooling 3. The second alignment device 2′ includes at least two openings 26′ and 27′ provided to receive one or more screw-nut systems 32, 34, 35 represented in FIG. 4. The two openings are then positioned facing the two openings 26, 27 of the alignment device 2 in order to make the tooling 3 integral with the alignment device 2.

When the part forming the free end 101 of the axial element 10 is introduced into the opening 21 of the alignment device 2, a portion 101 passes through it to be next inserted into an opening 41 of the mechanical part 4. The portion 103 is aligned by means of the assembly 11 and 10 which, on screwing down on the nut 12, will push the fingers 13 which will pivot and which will be in the housing 22.

The nut 12 includes at least one moveably mounted finger 13.

The or each finger 13 includes a working part 131 and an attachment part 132. The working part 131 includes two lateral faces 134 and 135 intended to form respectively a first support in contact with the inner surface of the opening 21 and a second support in contact with a portion of the circumference of the portion 103 of the axial element 10 when the axial element 10 is inserted in the opening 21 of the alignment device 2.

The or each finger 13 is rotationally moveable with respect to an axis, in the form of a pivot received in the housing 136, substantially arranged perpendicularly to the longitudinal axis X-X and in a plane orthogonal to the longitudinal axis X-X, between:
a first position in which the main axis of the working part 131 may be oriented so as to define a non-zero angle with the axis X-X and;
a second position in which the main axis of the working part 131 is parallel to the axis X-X. This latter position corresponds to a locking or a blocking of the part 103 of the axial element 10 in the opening 21. The fingers 13 pivot and enable a centring and tightening on the inner diameter of said opening 21.

The plurality of fingers makes it possible to favour the blockage of the translation of the axial element 10 while offering a greater stop surface.

The axial stop is produced thanks to the nut 12 which exerts:
on the one hand, a radial maintaining of the end of the axial element 10 in the opening 21 into which it is introduced and;
on the other hand, a centring of the axial element in said opening 21.

The axial maintaining of the axial element 10 thanks to the stop 133 is achieved by means of the shoulder 106 of the axial element 10 making it possible to offer a bearing surface. This stop 133 serves to push the fingers and to make them pivot.

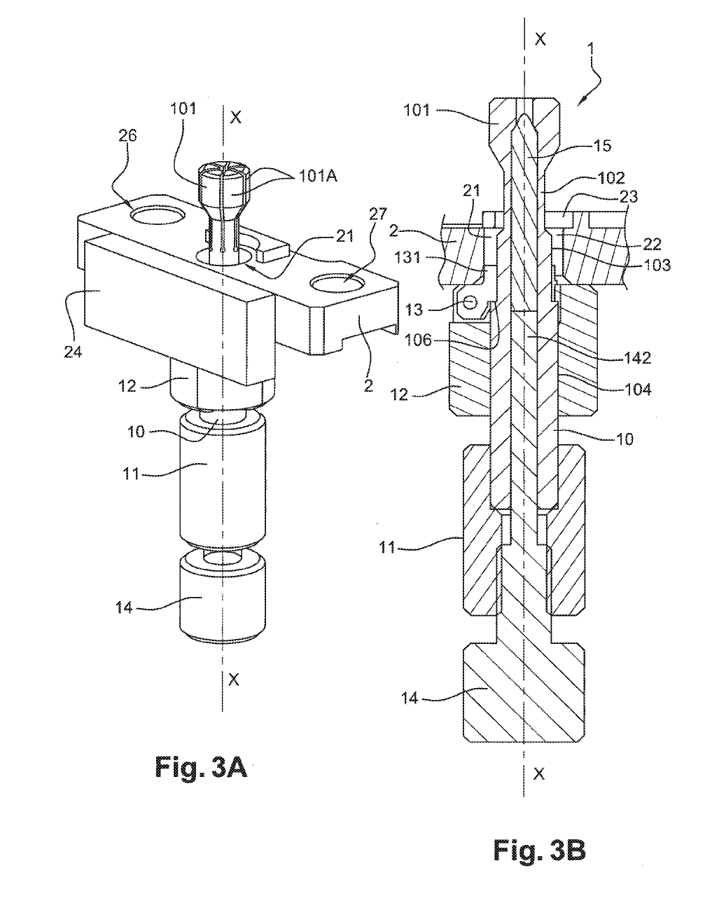

FIGS. 3A and 3B represent the coupling between the positioning 1 and alignment 2 devices, and show the finger 13 in its second position. One advantage of each finger 13 is that it may be changed or adapted depending on the use or the ageing of the other parts.

According to one embodiment, the nut 12 includes a plurality of fingers 13, for example two or three fingers 13 regularly angularly spread out over the circumference of the nut 12.

During an action of rotation of the support 11 with respect to the axis X-X in a first direction, the axial element 10 is translationally displaced along the axis X-X until the shoulder 106 of the element 10 comes into contact with the stop 133 of the finger 13. By continuing the action of rotation of the support 11, the or each finger 13 pivots, in such a way that the free end 134 of the finger 13 comes closer to the inner surface of the opening 21. When the free end 134 comes into contact therewith, an additional rotation of the support 11 causes an increase in the contact pressure between the finger 13 and the opening 21 in such a way that the positioning device 1 becomes integral with the alignment device 2. A rotation in a second direction of the support 11 drives the release of the devices. The contact enables a radial maintaining of the axial element 10 along one insertion axis by friction effect.

The fingers 13 are pivotably mounted on the nut 12 and can pivot during the implementation of the positioning device 1. The fingers 13 pivot by the contact between the surface 106 of the axial element 10 and the surface 133 of each finger 13. Said pivoting makes it possible to carry out a tightening between the surface 134 of each finger 13 and the inner surface of the opening 21. Hence, during their pivoting a longitudinal surface 135 of the stop 131 makes it possible to form a contact with a part of the circumference of the portion 103 of the axial element 10. This contact enables a radial maintaining of the axial element along one insertion axis.

Moreover, under the action of the axial element 10, the fingers 13 can radially move apart leaving a tightening margin of several millimetres in the diameter of the opening 21. For example, in the case in a mechanical part representing the fan disc 4 of a turbojet engine the diameter can vary from 12 to 14 mm.

The first portion 101 is adapted to be introduced into an opening 41 in a mechanical part 4, such as a fan disc, to form a positioning mark. Consequently, the first portion 101 is designed so as to cooperate with play when it is in rest position in the inner diameter of the opening 41 in which it will be positioned. The first portion 101 includes a cylindrical male profile and at least two grooves 100 in order to carry out a centring making it possible to adapt the diameter of the portion 101 to the circumference of the opening 41 by the radial spacing of the cylindrical male profile.

According to one embodiment, the grooves 100 are extended on the portion 102 having a smaller diameter than the portion 101 of the axial element 10. The extension of the grooves 100 on the portion 102 makes it possible to obtain greater amplitudes of radial movement of the legs and better bending deformation as detailed hereafter during the introduction of the tip 15.

According to one embodiment, a plurality of grooves 100 extend on the first longitudinal portion of the end 101 and enable a homogeneous spacing of the axial element 10.

FIGS. 1A and 3A represent an embodiment in which the extremal portion 101 comprises six grooves separating six legs 101 A. The grooves 100 enable an elastic radial spacing of the extremal portion 101. According to one favoured embodiment, the spacing of the extremal portion 101 is generated thanks to a tip 15 axially moveable in the passage 107 of the axial element 10. The tip 15 may be driven, according to one embodiment, by the screw 14 establishing an inner contact with said tip 15. When the tip 15 is engaged in the passage 107 and in contact with the conical contraction 108 of the axial element 10, an axial component of the axial movement of the tip 15 in the direction of the short section 109 causes the outer radial spacing of the legs 101A. The legs separated by grooves from the end of the element 10 make it possible to increase the diameter of the positioning device. The positioning device 1 may then be maintained by friction effect in the opening 21 of which the diameters correspond substantially to the increased diameter of the end 101.

Thanks to the tightening screw 14, easily accessible, it is possible to carry out progressive tightening.

In the example represented, the screw 14 and the tip 15 are two parts brought together and made integral. Thus, an untightening of the screw 14 of the positioning device 1 drives a movement of translation or slide of the tip of the end 101 tending to release the contact between the tip 15 and the conical contraction 108 and thereby favouring a reduction in the diameter of the extremal portion 101.

According to one embodiment, all the parts are made of aluminium. According to another favoured embodiment, the tip 15, the fingers 13 and the pivots are made of steel, which makes it possible to withstand greater mechanical loading of these parts which are subject to wear.

The devices implemented according to the invention are advantageous in that the maintenance of the positioning device 1 is facilitated since the parts, such as the fingers 13 or the tip 15, can be replaced easily.

FIG. 2A represents an example of mounting of the lifting tool 3 on the mechanical part 4. In this case, the mechanical part 4 is a fan disc. It is positioned flat on a table (not represented).

The structure of the tooling 3 includes fastening means for conduits forming vents. The latter are implemented during the passage in an acid bath to eliminate potential air pockets in the upper parts of a hollow part. This may be the case for the disc according to its orientation in the bath. The patent document FR1458856 details the implementation of such conduits.

The invention also relates to a method for mounting a positioning device on an opening or a drilling 41 of a mechanical part 4 so as to facilitate the mounting of a tooling 3 on the mechanical part 4.

In a first step, the positioning of at least one mask 5 on an outer portion of the disc 4 is carried out. To this end, the circumferential openings 41, forming fastening holes, may be used to fasten a mask 5 as represented in FIG. 2B. A mask 5 may, for example, include different male parts adapted to the diameter of the circumferential openings 41 of the mechanical part 4. A mask makes it possible, as is represented in FIG. 2A, to centre the structure of the tooling 3 on the disc 4. Advantageously, a second mask 5 may be used with the first mask 5 so as to balance the positioning of the tooling 3 on the circumference of the mechanical part 4.

In a second step, the positioning device 1 is made integral with the alignment device 2. It is laid out such that the portion 103 of its axial element 10 penetrates into an opening 21 of the alignment device 2 and that it is maintained therein. The positioning device 1 is fastened to the alignment device 2 thanks to the support 11, to the nut 12 and to the screw thread 104 between the support 11 and the nut 12.

A plate 2′ welded to the structure is laid out to ensure an alignment with the mask 5. Thus, it makes it possible to lock and to position the tooling structure 3 relative to the opening 41 of the part 4 chosen to insert therein the positioning device 1.

According to one embodiment, the alignment device 2 is considered as an element of the positioning device 1.

FIG. 2B represents a mask 5 including a hollowed out central zone making it possible to free the opening 41 of the part 4 and to make it accessible so that the plate 2′ of the tooling 3 cooperates in its length with the main axis of the mask 5. One interest of the positioning device 1 of the invention is to make it possible to position with great precision the openings of the plate 2′ of the tooling 3 facing the openings of the alignment device 2 of the invention.

The fastening of the positioning device 1 is carried out by radial expansion of the fingers 13 inserted into the opening 21 of the alignment device 2. To do so, the flat spot 12A of the nut is in abutment on the alignment device 2, which blocks any rotation of the nut 12. To drive the displacement of the axial element 10 in the fixed nut 12, the support integral with the axial element 10 is rotationally actuated with respect to the axis X-X, in its function of gripping means. Each finger 13 tends to block the axial displacement of the axial element 10 in at least one direction when the shoulder 106 comes into contact with the stop 133, as is represented in FIG. 3B.

In a third step, the positioning device 1 made integral with the alignment device 2 is mounted on the mechanical part 4, as represented in FIG. 4.

One advantage of the positioning device of the invention is a reduction in the size of such a part which makes it possible to centre two diameters of 12 mm and 10 mm, knowing that the diameter of 12 mm will evolve to 14 mm when the tooling has undergone numerous use cycles.

The solution of the invention makes it possible to take advantage of the use of two materials to produce the positioning device of the invention. Indeed, the elastic resistance of aluminium offers relative flexibility to ensure an operation during the different life cycles of the tooling as well as a hardness markedly less than that of the mechanical part which will not risk damaging it. Finally, the positioning device makes it possible to transform an axial movement into a radial movement in order to ensure precise tightening.

The invention enables a simple mounting of the tooling 3 on the mechanical part 4. Positioning of the mounting may be ensured with great positional precision and does so in a recurrent manner, because the tooling will not undergo significant wear at the level of these junctions. According to the example of FIG. 3B, the wear could always be taken into account such that the positioning device ensures a positioning by adapting itself to diameters ranging from 12 mm to 14 mm. This advantage notably makes it possible to limit the number of parts to replace.

According to one embodiment, an element 22 represented in FIG. 3B serves for the positioning of the axial device 10 of the invention and the element 23 is a zone which will be in contact with the engine part to tighten.

According to other examples, the variation in maximum dimension of an opening which may be taken into account by a displacement device 1 of the invention varies between 10% and 25%.

To summarise, the solution of the invention enables the centring of small diameters in a very restricted space. It is a system that could be used in numerous applications, and in different contexts.

1. A precision positioning device extending along an axis to be maintained in a first opening of a mechanical part, comprising an axial element provided with a passage, a nut, a support and a moveable element, said axial element being integral with the support, and comprising a first screw thread for mounting the nut on said axial element, said nut providing an axial stop blocking the axial movement of the axial element relative to the nut, said axial element an end portion comprising a deformable cylindrical male profile, adapted to cooperate with the inner circumference of the first opening, the deformation or radial expansion of the end of the axial element being driven by the action of the insertion of the moveable element in movement in the passage of the axial element in the direction of the end of the axial element.

2. The precision positioning device according to claim 1, wherein the support forms a gripping element permitting to drive the screwing down of the axial element into the nut.

3. The precision positioning device according to claim 1, comprising a screw forming a drive element tending to the elastic spacing of the deformable end, the screw thread of said screw cooperating with a tapping of the support and driving in axial movement the moveable element in order to engage the spacing of the cylindrical male profile of the free end of the axial element.

4. The precision positioning device according to claim 1, wherein the cylindrical male profile of the free end of the axial element includes at least one groove favouring the radial spacing of the cylindrical male profile.

5. The precision positioning device according to claim 4, wherein the free end of the axial element includes a plurality of grooves extending on a longitudinal portion of the end and enabling a homogeneous spacing of the axial element.

6. The precision positioning device according to claim 1, wherein the positioning device includes at least one finger pivotably mounted on the nut and comprising, moreover, a working part permitting to achieve a radial maintaining during the tightening driven by the rotation of the assembly formed of the axial element and support.

7. The precision positioning device according to claim 6, wherein the support, the nut and the axial element are made of aluminium and that the fingers and the moveable element are made of steel.

8. The precision positioning device according to claim 6, further comprising an alignment device including at least one second opening for the passage of a portion of the axial element, the opening cooperating with at least one working portion of at least one finger and a portion of the axial element.

9. A system for positioning a tooling structure to be positioned on a mechanical part, said structure including at least one opening, the positioning system comprising a positioning device according to claim 3 adapted to cooperate by insertion with a first opening of said mechanical opening, wherein the positioning device is made integral with the first opening by the actuation of the screw to:
align at least one third opening of the alignment device with at least one opening of a tooling structure.

10. A method for mounting a precision positioning device of claim 1, said positioning being carried out on a mechanical part comprising at least one opening for the passage of a maintaining end piece corresponding to a free end of the positioning device, comprising:
positioning at least one mask on the mechanical part in order to place and support a tooling of the mechanical part;
fastening an alignment device with the positioning device by the action of screwing down the axial element with respect to the nut;
positioning the positioning device and the alignment device in the opening of the mechanical part;
tightening to fasten the positioning device on the mechanical part by the action of an axial component of a movement of the moveable element with respect to the axial element driving the spacing of the free end of said positioning device in such a way that the portion of the free end exerts a radial effort in said opening.

11. The precision positioning device according to claim 1, wherein the moveable element is a tip or a slide.
